(19) United States
(12) Patent Application Publication
(10) Pub. No.: US 2001/0003454 A1
(43) Pub. Date: Jun. 14, 2001

(54) METHOD AND APPARATUS FOR MAPPING A DIGITAL VERSATILE DISK (DVD) IMAGE ONTO HIGH RESOLUTION COMPUTER DISPLAY DEVICE

(76) Inventor: PAUL CHAMBERS, SAN JOSE, CA (US)

Correspondence Address: North America Corp., U S PHILIPS CORPORATION, 580 WHITE PLAINS ROAD, TARRYTOWN, NY, 10591, US

(21) Appl. No.: 09/107,524

(22) Filed: Jun. 30, 1998

(51) Int. Cl. G09G 5/26

(52) U.S. Cl. 345/418

(57) ABSTRACT

A method and apparatus for displaying an anamorphically compressed image on a computer monitor performs a horizontal stretching of the image. An interpolation mechanism is employed to convert a 720×480 pixel resolution image recovered from an image storage medium into a horizontally stretched 800×480 image suitable for display on the computer monitor in a high resolution display mode. The horizontal stretching of the image, in contrast to vertical squeezing of the image, avoids loss of vertical resolution in the displayed image.

### FIELD OF THE INVENTION

The present invention relates to the field of displaying images retrieved from an image storage medium, and more particularly, to mapping an anamorphically compressed image, such as that commonly stored on a digital versatile disk (DVD), onto a high-resolution computer display device.

### BACKGROUND OF THE INVENTION

Digital versatile disk (DVD) technology is a relatively new technology that is gaining widespread popularity in both the computer and home multimedia arenas. This is due to a number of advantages provided by DVD technology, chief among them being the great amount of information that may be stored on a DVD. A particular DVD may store an image in either 4:3 or 16:9 aspect ratio (which has been anamorphically squeezed into the 720×480 pixels available). If the DVD is encoded as 4:3, a “pan and scan” processing or “letterbox” processing has been applied by the mastering house before the image was placed on the disc.

For an anamorphically encoded disc, a DVD player may output the 720×480 pixel image unmodified, which is appropriate if the display already has a 16:9 aspect ratio. The DVD player can also provide pan and scan processing to stretch the image horizontally by a factor of 1.33, then truncate the ends according to information stored on the disc. Finally, the DVD player can perform letterbox processing to reduce the image vertically by a factor of 1.33 and display black bars above and below the displayed image.

The DVD images are stored on the disk with a resolution of 720×480 pixels. The storage format uses MPEG-2 encoding (i.e., discrete cosine transform-based encoding). In the pan and scan mode, only part of the image is shown and portions that fall beyond the border of the screen are discarded. Finally, the letterbox version requires squeezing the image vertically, which results in a distortion of the image that was encoded. In effect, the vertical squeeze by a factor of 1.33 matches the horizontal squeeze of 1.33 required to encode the anamorphic image. The result is an undistorted image. In other words, the horizontal and vertical scaling will then be the same, and the aspect ratio of the original content restored. However, a viewer will receive the impression that details are lost in the central portion of the screen.

As stated earlier, DVD technology is relevant to both home multimedia displays, such as televisions, as well as in the computer arena. DVD images therefore are displayed on both television monitors and on computer monitors. The displaying of DVD images on television monitors are discussed above. Computer displays typically have an aspect ratio of 4:3 and normally operate at one of two or more resolutions, 640×480 pixels or 800×600 pixels. The conventional methods for mapping a DVD image to computer display in the 640×480 mode modifies the 720×480 DVD image that is recovered from the DVD to fit into the 640×480 resolution screen. This is essentially accomplished at a decoder stage of the DVD player. The downsampling by the decoder essentially squeezes the image recovered from the DVD in order to map it onto the 640×480 pixel display. The aspect ratio of the image displayed on the computer monitor is 16:9. This is produced by maintaining the number of horizontal pixels at 640 and reducing the number of vertical lines in the displayed image to 360. The 640×360 pixel image maintains the widescreen look (16:9) of the DVD image. However, squeezing the number of horizontal pixels from 480 pixels recovered from the DVD image to 360 pixels for display results in discarding 25% of the vertical information. This results in an undesirable reduction of resolution in a DVD image displayed on a computer monitor operating at standard display resolution mode.

The squeezing of an image and the consequent loss of vertical resolution makes the displaying of DVD images on a standard computer display less desirable.

### SUMMARY OF THE INVENTION

There is a need for method and apparatus to display an image recovered from a DVD, or other anamorphically compressed image data, on a standard computer display having an aspect ratio of 4:3 without a loss of vertical information.

This and other needs are met by embodiments of the present invention, which provide a method of displaying an image stored on a digital versatile disk (DVD) on a computer monitor. The method comprises retrieving an image from a DVD, where this image has M×N pixels. The image is then expanded to X×Y pixels. The product of X×Y is greater than the product of M×N. The expanded image is then displayed at a resolution of X×Y pixels on the computer monitor.

In the present invention, the resolution of the display device is increased, rather than scaling the DVD image down, to display it on a standard resolution device. For example, an original DVD image may be 720×480 pixels. Instead of squeezing the image to a 640×360 image (keeping a 16:9 aspect ratio), the present invention may produce an image that is 800×480 pixels centered in an array of 800×600 black pixels, providing a letterbox effect on a display with a resolution of 800×600 pixels. Stretching the image horizontally and displaying it as a higher resolution image in accordance with the present invention avoids the complexity of squeezing an image vertically. It also avoids the significant image degradation due to unavoidable loss of vertical detail that accompanies the squeezing of an image vertically. Synthesizing additional horizontal information is a much less complex process. Further, since no original image content is lost, image quality maintained. Depending on the sophistication of the horizontal upscaling technique that is employed, the perceived quality of the displayed image can actually be improved.

A number of different stretching schemes may be employed, in dependence upon the resolution of the computer display or monitor. For example, assuming that the display monitor may have a display resolution of 800×600 pixels, the 720×480 image retrieved from the DVD may be expanded by a direct mapping to an 800×480 pixel region of an 800×600 display. This direct mapping produces a 1.66:1 aspect ratio, which does not deviate greatly from the 1.77:1 (16:9) ratio of the stored DVD image. Hence, the viewer does not see a noticeable distortion of the image that was originally stored on the DVD. This is in contrast to the image produced on a computer monitor in standard resolution mode by squeezing the image in accordance with the prior art.

In another embodiment of the present invention, the 720×480 image is expanded in the horizontal direction to an 852×480 image for display. This maintains a 1.77:1 aspect ratio, equivalent to a 16:9 wide screen aspect ratio. In this embodiment, the 26 pixels on both sides of the picture are discarded during the display of the image. This represents a discarding of approximately 3% of the information on each side of the image. Discarding 3% of information from the left and right edges of an image is acceptable since computer monitors display all pixels (known as “underscanning”) in contrast to televisions, which typically “overscan” between 5 and 10% on all four edges. With this in mind, video material is created with all of the important content in the central 80% of the image (the so-called “safe area”) so that it may be viewed on all televisions, regardless of unit-to-unit tolerances. Hence, displaying all vertical information and 94% of the horizontal information on a computer monitor will display more than is typically seen on a television.

The earlier stated needs are also met by another aspect of the present invention which provides an image processing arrangement for generating a high-resolution display signal containing images stored on a DVD. The arrangement includes an image signal input that receives an image signal containing low-resolution images retrieved from a DVD. Image expansion circuitry is coupled to the image signal input. The image expansion circuitry expands the low-resolution images to generate high-resolution images. A display signal output is coupled to the image expansion circuitry to receive the high-resolution images and output a high-resolution display signal formed from the high-resolution images. In certain embodiments of the present invention, the sets of pixels in the low-resolution images are 720×480 sets of pixels. Each high-resolution image generated by the image expansion circuitry comprises an 800×600 pixel resolution image.

One of the advantages of the present invention is the relatively standard components that may be employed to produce an improved image on a computer monitor.

Additional advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

FIG. 1 is a block diagram of an arrangement for retrieving a DVD image from a DVD and displaying the image on a computer monitor.

FIG. 2 is a graphic representation of the displaying of an image recovered from a DVD on a computer display in accordance with the methods of the prior art.

FIG. 3 is a graphic representation of the displaying of an image on a high-resolution computer display in accordance with an embodiment of the present invention.

FIG. 4 is a graphic representation of a method of displaying an image retrieved from a DVD on a high-resolution computer display in accordance with other embodiments of the present invention.

FIG. 5 is a block diagram of certain components of a DVD player constructed in accordance with an embodiment of the present invention.

### DETAILED DESCRIPTION OF THE INVENTION

The embodiments of the present invention provide methods and apparatus for displaying a DVD image recovered from a DVD on a computer display. In contrast to prior art methods of displaying the image, the present invention avoids the loss of vertical information from the retrieved image when it is displayed.

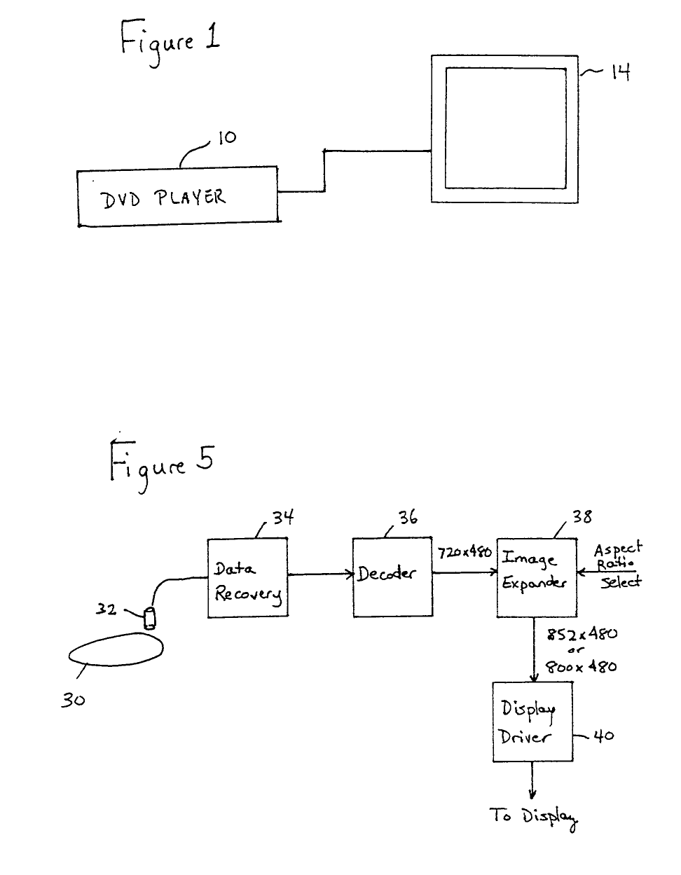

FIG. 1 is a basic block diagram of some of the components that may be used to recover images from a DVD and displaying it on a computer monitor. The arrangement includes a DVD player 10 that is coupled to a computer monitor (or display) 14. The DVD player 10 may be either a stand-alone unit or may be incorporated within a computer, or other multi-functional equipment. The computer monitor 14 has multiple display resolution modes. For example, in a low-resolution mode, the computer monitor 14 has a 640×480 pixel resolution. In a high-resolution mode, the computer monitor 14 has an 800×600 pixel resolution. Conventional displays have a 4:3 aspect ratio, providing a relatively squarish appearance.

The 800×600 mode does not have to be selected by the user, as most computer monitors can be interrogated to discover their abilities through Display Device Protocol (DDC). The DVD player 10 is able to determine if the image is anamorphic from information encoded on the disc. Thus, the DVD player 10 is able to determine automatically when the technique of the present invention can be applied. It is also possible for the user to indicate if the monitor is capable of 800×600 resolution when initially setting up the DVD player 10 (if it does not support DDC, for example). The DVD player 10 would then handle this automatically after it has been set up initially by the user.

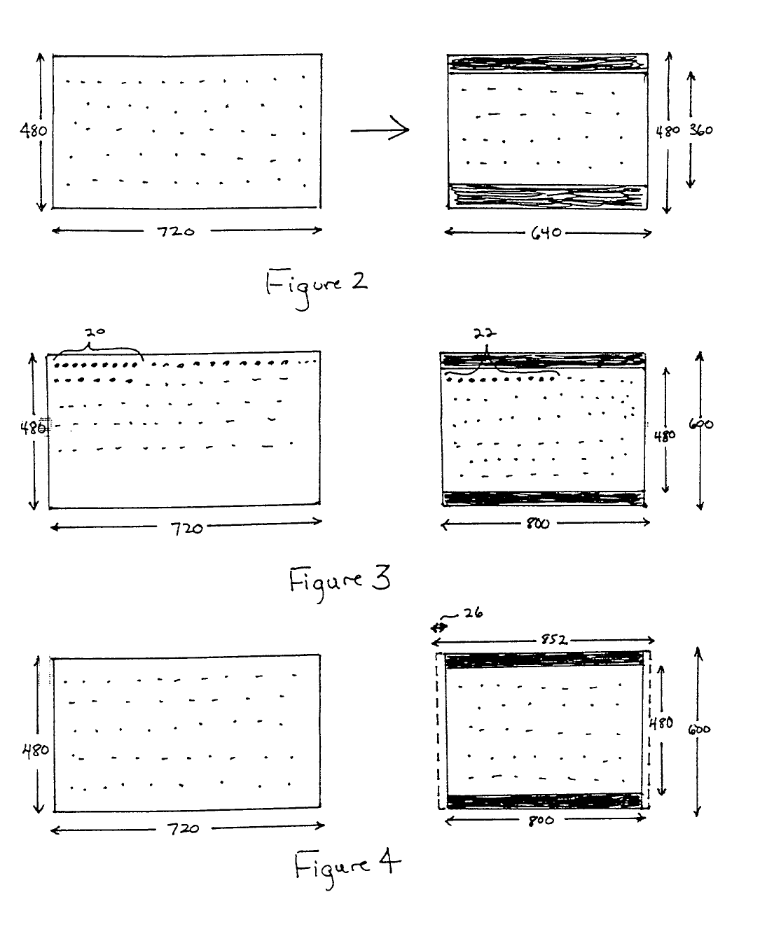

FIG. 2 is a graphic representation of the prior art transformation of the image recovered from the DVD to the computer monitor 14 when it is operating at a standard, low-resolution mode of 640×480 pixels. The image retrieved from the DVD is depicted on the left as an array of 720×480 pixels. The image represented has a 1.33:1 aspect ratio (4:3), unless the image has been anamorphically squeezed. Typically, in a wide screen format on a television, the image is displayed at a 1.77:1 ratio. The image is stored as an anamorphically compressed image on the DVD so that the expansion to a 1.77:1 ratio produces an acceptable image to the viewer. When provided to a computer monitor, however, in accordance with the prior art, the original 720×480 image is squeezed vertically in order to fit in the confines of the computer monitor 14. The computer monitor 14 is set at a low-resolution of 640×480 pixels. The decoder of the DVD player typically performs a down sampling to convert the 720×480 recovered image to a 640×360 image. This produces an aspect ratio of 1.77:1 (or 16:9), the preferred wide screen aspect ratio. In the squeezing down of the image from 720×480 pixels to 640×360 pixels, approximately 25% of the vertical information is discarded, so that the vertical resolution is dramatically reduced. Hence, the displaying of images on a computer monitor 14 at standard, low-end display resolution in accordance with the methods of the prior art produces unacceptable images.

FIG. 3 depicts a graphic representation of the mapping of a DVD image in accordance with an embodiment of the present invention that avoids the discarding of vertical information while producing an acceptable image in a computer display. The image recovered from the DVD remains at 720×480 pixel resolution. However, rather than squeezing the image in order to make it fit into the low-resolution display of the computer monitor 14, the DVD image is “stretched” slightly and displayed by a computer monitor 14 that is in a high-resolution mode. In the exemplary embodiment depicted in FIG. 3, the computer monitor 14 is in a high-resolution mode of display in which the resolution is set at 800×600 pixels. A direct mapping is performed in which the 480 pixels in the vertical direction are unchanged, and the 720 pixels in the horizontal direction are expanded to 800 pixels. The 800×480 pixel resolution image that is displayed on computer monitor 14 represents a 1.66:1 aspect ratio. This aspect ratio approximates the desired 1:77:1 (16:9) aspect ratio of a wide screen television, but at the same time advantageously allows direct mapping.

The mapping that is performed to transform the image from a 720×480 pixel resolution image to an 800×480 pixel resolution image is a 9 to 10 mapping. In such a mapping, every set of 9 horizontal pixels (reference numeral 20 on the left-hand side of FIG. 3) are converted to a set of 10 pixels (reference numeral 22 on the right hand side of FIG. 3). This 9 to 10 mapping is performed for all of the pixels in the array in the recovered DVD image.

One of the advantages of stretching the recovered DVD image over modifying the image vertically is the reduced amount of memory required to perform the transformation. For example, in order to do a 9 to 10 transformation in the vertical direction, the pixel values for 9 complete horizontal lines would need to be stored for further manipulation and interpolation. By contrast, the horizontal stretching of the covered DVD image only requires storing 9 pixel values prior to interpolation. The difference in the number of pixel values that need to be stored is therefore 9 vs. 4320 (480 pixels×9 lines). The present invention therefore requires much less memory to perform the interpolation.

As shown in the right hand side of FIG. 3, the displayed image has black bands on the top and bottom of the monitor 14. Hence, the DVD image as displayed on the computer monitor 14 is in the wide screen format.

FIG. 4 depicts another embodiment of the present invention in which the anamorphically compressed 720×480 pixel array DVD image is transformed for display on a high-resolution computer monitor 14. In this embodiment, the image is stretched horizontally as in the embodiment of FIG. 3 from 720×480 pixels to 852×480 pixels. The image is thus stretched to a ratio of 1.77:1 rather than 1.66:1, as in FIG. 3. This produces a 16:9 aspect ratio, which is the standard widescreen format. The computer monitor 14, however, only has a resolution of 800×600 pixels. Thus, only 800 of the 852 pixels in a horizontal direction may be displayed. According to embodiments of the present invention, 26 pixels on each end of the image are dropped. The dropped 26 pixels represent approximately 3% of the horizontal information. This information on the sides of the image is usually not critical to a video image, such as a movie, so that dropping this portion of the image should not unduly affect the viewing experience. Furthermore, typical television monitors overscan by 5 to 10% (i.e., drop about 5 to 10% of an image on the side of an image). Dropping of the 26 pixels on each end of a horizontal line does not exceed this range of overscan and is therefore considered an acceptable loss of image.

As in the embodiment of FIG. 3, the embodiment of FIG. 4 does not stretch the image in a vertical direction, so that the image remains at 480 pixels in a vertical direction. Black bands appear above and below the image in the computer monitor 14, as reflected in the right hand side of FIG. 4.

The mapping required to stretch the image horizontally to achieve 852 pixels in a horizontal line from the 720 pixels is a 6 to 7 mapping. In other words, every 6 pixels in the original image are mapped and replaced by a set of 7 pixels in a horizontal line.

The mapping performed to stretch the image horizontally may be done in a number of conventional manners. The preferred method is by simple interpolation, with either 9 to 10 mapping or 6 to 7 mapping, as described above. Conventional interpolation circuitry may be employed to provide this mapping. Specifically, an MPEG-2 decoding process uses frequency-domain coefficients to describe 8×8 pixel blocks, and an inverse discrete cosine transform to convert them back to a spatial two-dimensional representation. The exemplary horizontal scaling techniques described in the present invention are readily incorporated into this existing decoding process. Furthermore, other methods of expanding an image, such as spectral transformation, may be employed without departing from the scope of the invention.

An exemplary embodiment of the data recovery and image expansion circuitry is depicted in FIG. 5. A DVD 30 is scanned by a DVD reader 32. The signal recovered by the DVD reader 32 is communicated to a data recovery circuit 34 that includes, for example, an analog to digital converter to convert the signals into a digital data stream. Recovered data is then provided to a decoder 36. Unlike convention decoders, however, this decoder 36 does not perform a downsampling of the recovered image. If a conventional decoder 36 is employed that includes a downsampler, the downsampler should be bypassed for optimum performance. Otherwise, the downsampled image merely has to be expanded further. It is preferred, however, to avoid downsampling before upsampling as this degrades the final image that is displayed.

The decoder 36 outputs a 720×480 image in the form of a digital data stream. This image is received by an image expander 38 which may be a convention interpolation circuit, for example. As stated earlier, the interpolation may be formed to produce an image that is 852×480 pixels (1.77:1 aspect ratio) or an 800×480 pixel array (1.66:1 aspect ratio). This is selectable by the user via an aspect ratio select signal which serves as an input to the image expander 38. Depending on the aspect ratio select signal input by the user, the image expander will output the 852×480 pixel resolution image or the 800×480 pixel resolution image as a serial data stream to a display driver 40 that buffers and outputs the image to the computer monitor 14 for display.

Some specific examples of pixel resolution images have been provided for ease of explanation and clarity in understanding the invention. It should be recognized by those of skill in the art that these pixel resolution images are exemplary only. Other transformations of the anamorphically compressed recovered image to expand in a horizontal direction for display on a high resolution monitor are within the spirit and scope of the present invention.

While this invention has been described in connection with what is presently considered to be the most practical and preferred embodiments, it is to be understood that the invention is not limited to the disclosed embodiments, but, on the contrary, is intended to cover various modifications and equivalent arrangements included within the spirit and scope of the appended claims.

What is claimed is:

1. A method of displaying an image stored on a digital versatile disk (DVD) on a computer monitor, comprising the steps of:
retrieving an image from a DVD, the image having M×N pixels; expanding the image to X×Y pixels, where the product of X×Y is greater than the product of M×N; and
displaying the expanded image at a resolution of X×Y pixels on a computer monitor.

2. The method of claim 1, wherein M×N is equal to 720×480.

3. The method of claim 2, wherein X×Y is equal to 800×480.

4. The method of claim 3, wherein the step of expanding includes interpolating the pixels in the image.

5. The method of claim 3, wherein the step of expanding includes spectrally transforming the image.

6. The method of claim 1, wherein the step of expanding includes initially expanding the image to P×Q pixels, and discarding a number of pixels to read X×Y pixels.

7. The method of claim 6, wherein M×N is equal to 720×480, P×Q is equal to 852×480 and X×Y is equal to 800×480.

8. An arrangement for displaying an image stored on a digital versatile disk (DVD), comprising:
a DVD drive configured to receive a DVD and retrieve images stored on the DVD in an M×N format;
a computer monitor having a resolution of X×Y pixels, wherein X×Y is greater than M×N; and
an image processor coupled to the DVD drive and the computer monitor and including a DVD image expander that receives from the DVD drive the images retrieved from the DVD, expands the retrieved images from an M×N format to an X×Y format, and provides the expanded images as a display signal to the computer monitor.

9. The arrangement of claim 8, wherein the images are stored on the DVD in a 720×480 format.

10. The arrangement of claim 9, wherein the computer monitor has a display resolution of 800×600 pixels, and X×Y is equal to 800×480.

11. The arrangement of claim 10, wherein the image processor includes interpolation circuitry that generates interpolated pixels in the images retrieved from the DVD to generate the expanded images.

12. An image processing arrangement for generating a high-resolution display signal containing images stored on a digital versatile disk (DVD), comprising:
an image signal input that receives an image signal containing low-resolution images retrieved from a DVD;
image expansion circuitry coupled to the image signal input, the image expansion circuitry expanding the low-resolution images to generate high-resolution images; and
a display signal output coupled to the image expansion circuitry to receive the high-resolution images and output a high-resolution display signal formed from the high-resolution images.

13. The image processing arrangement of claim 12, wherein each low-resolution image comprises a set of pixels, and the image expansion circuitry includes an interpolator for generating additional pixels and inserting the additional pixels within the set of pixels to generate a high-resolution image.

14. The image processing arrangement of claim 13, wherein the sets of pixels in the low-resolution images are 720×480 pixel resolution sets.

15. The image processing arrangement of claim 14, wherein each high-resolution image generated by the image expansion circuitry with additional pixels comprises an 800×480 pixel resolution image.

16. The image processing arrangement of claim 12, wherein each low-resolution image comprises a set of pixels, and the image expansion circuitry includes a pixel generator for generating additional pixels and inserting the additional pixels within the set of pixels to generate a high-resolution image.

17. The image processing arrangement of claim 16, wherein the sets of pixels in the low-resolution images are 720×480 pixel resolution sets.

18. The image processing arrangement of claim 17, wherein each high-resolution image generated by the image expansion circuitry with additional pixels comprises an 800×480 pixel resolution image.
